(19) United States
(12) Patent Application Publication
(10) Pub. No.: US 2024/0214819 A1
(43) Pub. Date: Jun. 27, 2024

(54) POSITIONING-SYSTEM-AIDED DATA SOVEREIGNTY, DATA SECURITY, AND DATA AUTHENTICATION

(71) Applicant: ETHERWHERE CORPORATION, Sunnyvale, CA (US)

(72) Inventors: Farrokh Farrokhi, San Ramon, CA (US); Michael Raam, Los Altos, CA (US)

(21) Appl. No.: 18/393,526

(22) Filed: Dec. 21, 2023

Related U.S. Application Data
(60) Provisional application No. 63/476,613, filed on Dec. 21, 2022.
(60) Provisional application No. 63/480,672, filed on Jan. 19, 2023.

(51) Int. Cl. H04W 12/64; G01S 19/16; G01S 19/42; H04W 12/06; H04W 12/61

(52) U.S. Cl. CPC H04W 12/64; G01S 19/16; G01S 19/42; H04W 12/06; H04W 12/61

(57) ABSTRACT

Systems and methods are provided for enforcing data sovereignty. In one implementation, a server may be co-located with a GNSS receiver that samples GNSS satellite signals. The server determines whether a geolocation of the server as determined through the samples satisfies a data sovereignty requirement. If the data sovereignty requirement is satisfied, the server allows an operation such as access to an associated database. If the data sovereignty requirement is not satisfied, the server refuses to perform the operation.

### CROSS-REFERENCE TO RELATED APPLICATIONS

This application claims the benefit of U.S. Provisional Application No. 63/476,613, filed Dec. 21, 2022 and claims the benefit of U.S. Provisional Application No. 63/480,672, filed Jan. 19, 2023, the contents of both of which are incorporated by reference herein.

### TECHNICAL FIELD

application relates to a positioning system, and more particularly to positioning-system-aided data security architecture and method.

### BACKGROUND

The geolocation of a data center is an important consideration for data sovereignty and also authentication. A user of a data center should thus be able to verify that the data center is in fact where it claims it is. But such verification is problematic in that a hacker may readily spoof the geolocation of a data center/server farm. A geolocation verification solution is thus needed that is both secure/tamper free as also low cost and easy to implement.

### SUMMARY

In accordance with an aspect of the disclosure, a method is provided for verifying an authenticity of a geolocation that includes: at a server, receiving a series of samples of a satellite positioning system (SPS) satellite signal from a global navigation satellite system (GNSS) receiver that is substantially co-located with the server, wherein the series of samples are timestamped with a sampling time; processing the series of samples to determine a geolocation of the server; performing an operation at the server based upon the geolocation of the server being within a geofence; and preventing an operation at the server based upon the geolocation of the server being outside of the geofence.

In accordance with another aspect of the disclosure, a method is provided that includes: at a server, receiving a geolocation from a GNSS receiver while receiving samples of a wireless signal from the GNSS receiver; verifying that the samples correspond to what was known to be transmitted by a wireless signal source to verify an authenticity of the geolocation; performing an operation at the server in response to the geolocation of the server being within a geofence and in response to a verification of the authenticity of the geolocation; and preventing an operation at the server in response to the geolocation of the server being outside of the geofence and in response to a non-authentication of the geolocation.

In accordance with another aspect of the disclosure, a system is provided that includes: a GNSS receiver configured to sample a GNSS signal synchronously with an update in a navigation data overlay in the GNSS signal to form a series of samples; and a first server configured to transmit the series of samples to a remote server. A watermarked signal as sampled from an extra RF source may be downconverted and superimposed, in analog or digital domain, to the samples of the GNSS signal and are used for authentication of the GNSS signal.

In accordance with yet another aspect of the disclosure, a method is provided that includes: receiving a first series of samples of a RF data signal from, by way of example, one of a base station, a WiFi hotspot, and a communication satellite (or another geolocation satellite including but not limited to an LEO satellite, wherein the series of samples were sampled at the geolocation at a first network time; receiving a second series of samples of the RF data signal, wherein the series of samples were sampled adjacent the geolocation at the first network time; and verifying the geolocation by verifying that the first series of samples is sufficiently correlated with the second series of samples.

These and other advantageous features may be better appreciated through the following detailed description.

### BRIEF DESCRIPTION OF THE DRAWINGS

FIG. 1 illustrates a data center configured for secure geolocation authentication in accordance with an aspect of the disclosure.

FIG. 2 illustrates the data center providing a datagram to a remote server through the cloud in accordance with an aspect of the disclosure.

FIG. 3 is a timing diagram of the datagram sampling with respect to a navigation data update from a GNSS satellite in accordance with an aspect of the disclosure.

FIG. 4 illustrates a GNSS receiver and a RF data signal receiver producing a combined datagram in accordance with an aspect of the disclosure.

Implementations of the present disclosure and their advantages are best understood by referring to the detailed description that follows. It should be appreciated that like reference numerals are used to identify like elements illustrated in one or more of the figures.

### DETAILED DESCRIPTION

A data center could be configured to respond to server requests with an indication of its geolocation. But a hacker could readily spoof the geolocation of the data center. A user could then be receiving a response from a hacked data center. This is problematic with respect to verifying that data sovereignty and security is being honored. As disclosed herein, a data center may report its geolocation in a secure and virtually spoof-free manner yet at low cost and ease of implementation. The following discussion will be directed to a global navigation satellite system (GNSS)-based implementation of this geolocation authentication solution, but it will be appreciated that an entirely terrestrial wireless solution may be used in alternative implementations.

There are two main embodiments to be described herein. In a first embodiment, a server verifies its own location such as to satisfy data sovereignty requirements. In the prior art, a server could do so by simply checking its location through a co-located satellite-based positioning system such as a GNSS receiver. But such a geolocation verification is readily spoofed: a determined user could hack such a verification by using a synthesized geolocation. The server could thus be outside of a geofence that would otherwise be enforced through data sovereignty requirements. With the server being supplied with a synthesized (and false) geolocation, the server could continue to operate as if it were within a geofence despite actually be outside of the geofence. Alternatively, the server simply could have been moved outside of the geofence. This type of spoofing is advantageously solved herein by an association of the server with a GNSS receiver. But the GNSS receiver does not report its location but instead provides a series of samples of a positioning signal broadcast by a selected GNSS satellite. Such a series of samples is denoted herein as a “datagram.” As known in the GNSS arts, a GNSS satellite constellation transmits in the same frequency band. The GNSS receiver would thus be tuned to the appropriate frequency band during the datagram sampling.

The following discussion will assume that the GNSS receiver is a GPS receiver without loss of generality. The datagram would thus be sampling the particular subset of GPS satellites that are appropriately located in their orbits at the time of sampling. As known in the GPS arts, a sampling time of six seconds ensures that the time-of-week will be captured from each of GPS satellites in the subset being sampled. However, the datagram sampling time may be longer or shorter in alternative embodiments. Since the GNSS receiver is co-located or adjacent to the server, the datagram may be delivered to the server with relatively little delay. This delay would be determined by the networking protocol between the GNSS receiver and the server such that it would be in the millisecond range. The server may then correlate the datagram with the PRN codes for the GPS satellites in the subset being sampled. In that regard, the server may be configured with the GPS satellite ephemeris such that the server would know the identity of the GPS satellites that are sufficiently high in the sky so as to be sampled at the time of sampling. Given the identity of the PRN codes, the server may then proceed to correlate the datagram with the appropriate PRN codes so as to extract pseudo-ranges and then use the pseudo-ranges to determine the server's (and the GNSS receiver's) geolocation. In this fashion, the server may perform a robust verification of its geolocation as spoofing the datagram would require quite an investment by the hacker. In contrast, a prior art server may be readily spoofed by a synthesized (and false) geolocation. With the geolocation of the server determined through the processing of the datagram, the server may then determine whether its geolocation is within a geofence or otherwise satisfies a data sovereignty requirement. If the geolocation is within the geofence and/or satisfies a data sovereignty requirement, the server may proceed to perform an operation such as accessing a database. But if the geolocation is outside of the geofence and/or does not satisfy a data sovereignty requirement, the server may proceed to prevent an operation such as accessing the database.

In a second embodiment, a remote second server authenticates the geolocation of a first server. In such embodiments, the first server is co-located with or adjacent to a GNSS receiver. As discussed with regard to the first embodiment, the GNSS receiver may sample a datagram that the first server would forward to the remote second server. Note that in such a case, there may be some delay between the sampling of the datagram and the eventual authentication by the remote server. To address this delay, the GNSS receiver may timestamp the datagram with a time of sampling. In this fashion, the remote server may use the time of sampling to assist the correlation of the datagram with the appropriate PRN codes. The remote server would thus determine the geolocation of the second server (and its associated GNSS receiver) as discussed with regard to the first embodiment.

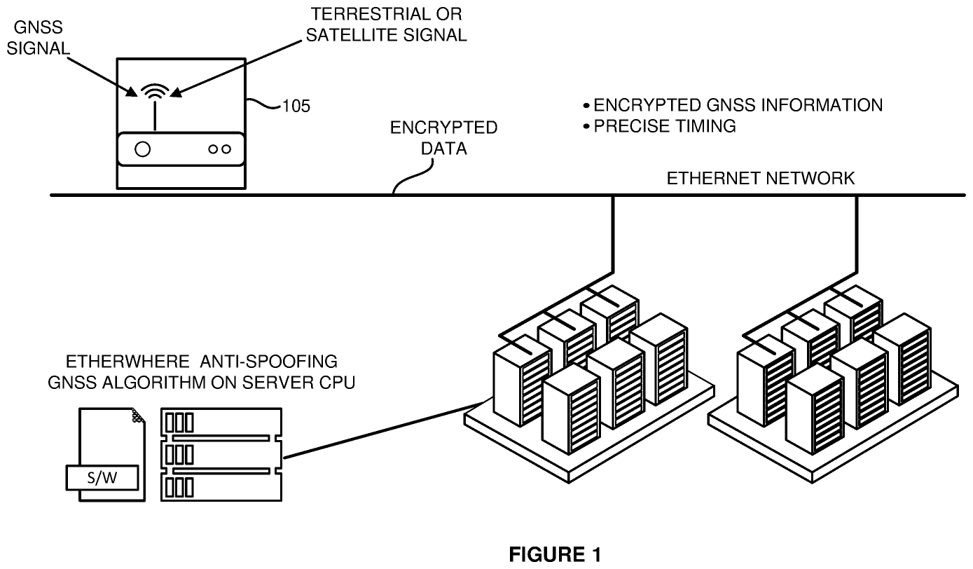

Turning now to the drawings, an example data center 100 with a global navigation satellite system (GNSS)-based location identification is shown in FIG. 1. The data center 100 includes a GNSS receiver 105 such as on a roof of a building enclosing the data center. In some embodiments, the GNSS receiver 105 does not process the received GNSS signals so as to extract a location of the data center 100 but instead merely samples the received GNSS signals at a rate sufficient for the eventual calculation of pseudo-ranges. The resulting GNSS signal samples are also referred to herein as a “datagram” or raw GNSS samples. GNSS receiver 105 encrypts the datagram (note that encryption of the datagram is optional), timestamps the datagram, and supplies the encrypted and timestamped GNSS samples to a network (e.g., an Ethernet network) coupled to a server in the data center 100. GNSS receiver 105 may be programmed with the appropriate encryption keys such as at manufacture. The server in data center 100 as discussed above with respect to the first embodiment (or a remote server as discussed above with respect to the second embodiment) may then process the datagram to determine the geolocation of the data center 100.

In one embodiment, the GNSS receiver 105 is frequently probed by an RTM (Root of Trust Measurement) application that runs on a server in the data center 100. To prevent a hacker to authenticate the location of the server at a known location and move the server to an unknown location afterwards, the geotag information has an expiration date that forces the server to monitor location frequently. Geotag data has location and timing information. In addition to the location, a sampling time is extracted by the server and cross validated with a known time stamp that could be inside the Trust Zone. In addition, the GNSS time may be extracted from the datagram and cross checked with the attached time stamp.

As discussed earlier for the first embodiment, the processing of the datagram may be performed in a server in the data center 100. The location and GNSS time extracted from the datagram is validated against the timestamp of the received signal and in addition with the local time at the server, to further validate the delay between the received time of the datagram against the GNSS time extracted from the datagram. This delay may be compared against a maximum allowed delay to filter out the possibility of a GNSS spoofer generating the signal.

With regard to some implementations, the GNSS receiver 105 may process the GNSS signals so as to extract a location rather than to merely sample a datagram. To provide additional security, the extracted location may first be “watermarked” by including with its transmission samples of a suitable wireless signal such as samples of a base station signal or a samples of a wireless communication satellite such as a Starlink satellite. In that regard, GNSS receiver 105 may also be a receiver of this watermarking signal in such embodiments. The watermarking signal samples provide enhanced security because the wireless communication source is always changing dependent on its data content. A server in data center 100 may have a database of samples of the wireless communication source or receive such samples from a remote server. By verifying that the samples correspond to what was known to be transmitted by the wireless communication source, the user can thus verify the authenticity of the extracted location. Note that the watermarking signal samples may also be mixed with the encrypted and timestamped datagram in embodiments in which the datagram is transmitted rather than the geolocation.

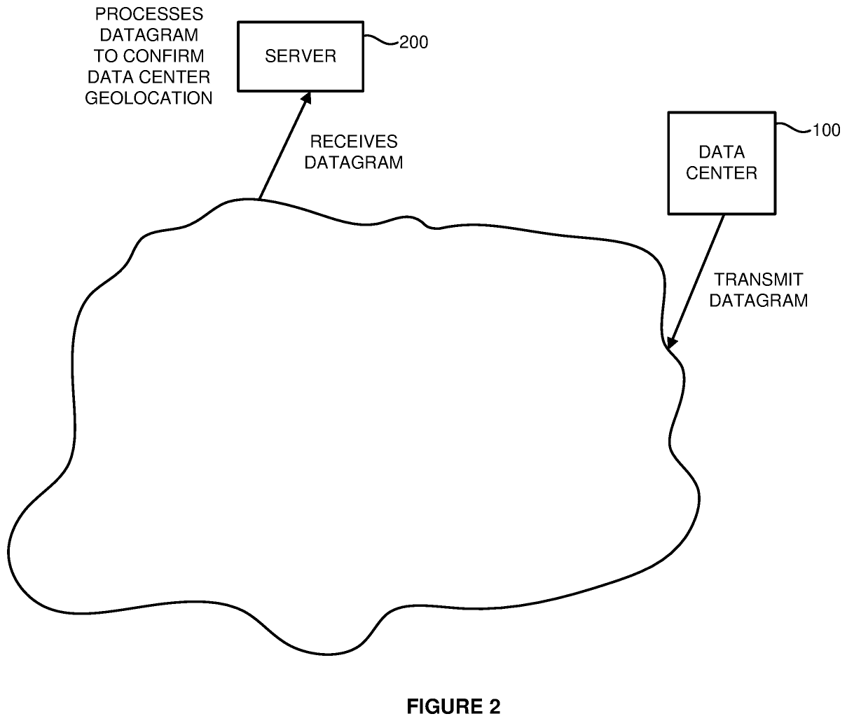

Data center 100 may be accessed such as through the cloud with a user's server 200 as shown in FIG. 2. In some datagram embodiments, the datagram may be sufficiently long enough (the data samples span a sufficient period of time) for server 200 to recover the navigation bits such as the clock correction. Although a GPS satellite has an accurate clock it is subject to minor inaccuracies compared to the current GPS time. A GPS satellite will thus regularly update its clock correction factor. More generally, a GPS satellite will update its navigation data approximately every 15 minutes. The update time is known a priori but the updated navigation data is unknown until it is transmitted by the GPS satellite. The geolocation identification disclosed herein exploits this update time by immediately sampling the datagram synchronously with the updated ephemeris. The transmission of the navigation data is relatively low bandwidth (50 bits per second). To ensure that a sufficient number of navigation bits are included in the datagram to identify that the datagram corresponds to the ephemeris update, the datagram may be approximately one second or greater in length in some implementations. As an example, the sampling rate of a GPS pseudo-random code (PRN) may be 4 MHz. If each sample is two bits, the datagram may be 8 Megabytes for every second sampled. Such an amount of data is readily transmitted over an enterprise network such as an Ethernet network to the data center and from the data center through the cloud to server 200.

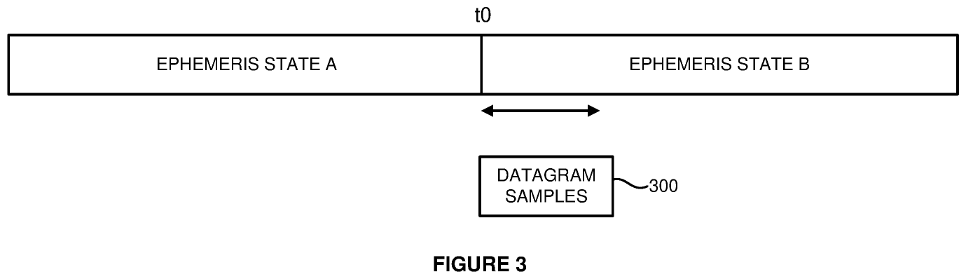

The resulting timing of a datagram 300 is shown in FIG. 3. The GNSS receiver knows a priori that an ephemeris update will begin at time t0 and thus begins sampling datagram 300 at that time. The GNSS receiver time stamps the datagram 300 with its network time. Prior to time t0, the ephemeris had a state A that transitions to a state B at time t0. It takes some time for a GPS satellite to transmit the entirety of the ephemeris update that makes up state B. But after this time, state B is established and will not change until the next ephemeris update. Server 200 may thus readily authenticate datagram 300 by verifying that the navigation data in datagram 300 corresponds to state B and has the network time beginning at time t0.

Note how powerful the resulting authentication becomes. A priori, a spoofer has no knowledge of what constitutes the updated ephemeris forming state B. After state B is established, the spoofer will indeed know what constitutes state B and could thus (conceivably) spoof a datagram by conjuring up the expected samples. But it takes some time to receive the navigation data and decode it. A spoofer is thus always at least 20 to 30 milliseconds behind time t0. In other words, it is virtually impossible for a spoofer to transmit datagram 300 at time t0 because the spoofer must wait to see what indeed the navigation data is going to become in state B.

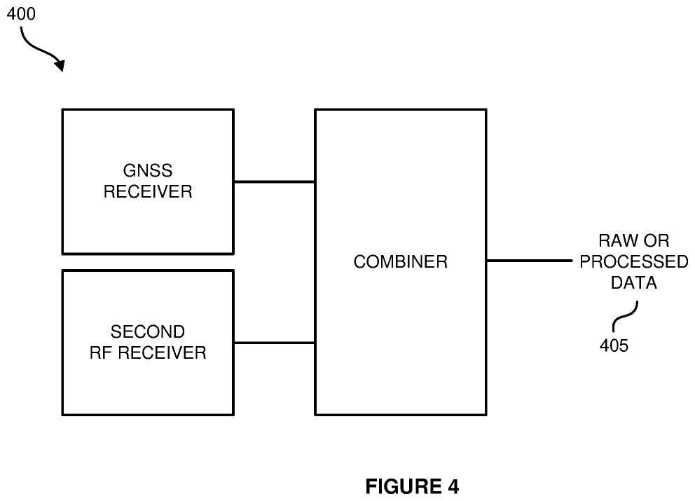

In another implementation, the GNSS receiver 105 may instead merely transmit its encoded geolocation as derived such as through conventional GPS signal processing. To authenticate such a geolocation, the GNSS receiver 105 is also configured to receive an RF data signal such as from a base station or from a communication satellite. Such an RF data signal will vary randomly as the data content varies. GNSS receiver 105 may thus be generalized as shown in FIG. 4. A second RF receiver is tuned to sample the RF data signal. The geolocation (or a datagram 300) is then combined with the RF data samples to form a combined datagram 405.

There is an issue with respect to processing combined datagram 405 in that an RF data signal will vary whereas a GPS satellite repeatedly transmits its pseudo-random (PRN) code along with the navigation data overlay. Server 200 may be configured with a copy of the PRN code, but it cannot know a priori what the RF data samples will be. To provide an analog of the PRN code copy, server 200 may be provided samples of the RF data signal from one or more receivers that independent of data center 100. These additional receivers may be denoted as “sniffers” in that they function to sample the RF data signal as an extension of server 200. Server 200 may thus autocorrelated the RF data signal samples from the additional receiver(s) with the RF data signal samples in the combined datagram 405. Note the extreme difficulty a spoofer would have in duplicating combined datagram 405: a priori, one does not know what the contents will be of an RF data signal such as transmitted by a base station, a WiFi hotspot, or a communications satellite (e.g., one of the constellation of Starlink satellites).

A spoofer could also sample the RF data signal, but it must correspond to the expected propagation delay at the data center's location. In addition, the RF data signal samples must correspond to the network time. A spoofer would thus have to be able to predict the a-priori-unknown contents of the RF data signal to be able to duplicate combined datagram 405 with the corresponding network timestamp. Regardless of whether datagram 300 or a combined datagram 405 is generated, the resulting authentication of the data center's geolocation may be performed in server 200, in the cloud, or in any other suitable location.

What is common to both datagram 300 and combined datagram 405 is that a GNSS satellite signal and an RF data signal has time critical information that is unique to the network time instant and to the data center's geolocation. Server 200 may thus compare the local accurate GPS time and the network time stamp of the receive datagrams to detect potential delay caused by hijacking and spoofing.

The specification will now be summarized through the following example clauses:
Clause 1. A method of verifying a geolocation, comprising;
   at a server, receiving a series of samples of a satellite positioning system (SPS) satellite signal from a global navigation satellite system (GNSS) receiver that is substantially co-located with the server, wherein the series of samples are timestamped with a sampling time;
   processing the series of samples to determine a geolocation of the server;
   performing an operation at the server in response to the geolocation of the server being within a geofence; and
   preventing an operation at the server in response to the geolocation of the server being outside of the geofence.
Clause 2. The method of clause 1, wherein performing the operation at the server comprises accessing a database.
Clause 3. The method of any of clauses 1-2, wherein performing the operation at the server comprises receiving data from a data center at the geolocation.
Clause 4. The method of any of clauses 1-3, wherein the series of samples are encrypted and wherein processing the series of samples includes decrypting the series of samples.
Clause 5. The method of clause 1, wherein the series of samples are timestamped with a time of receipt, the method further comprising:
   processing the series of samples to extract a GNSS time of transmission;
   comparing the GNSS time to the time of receipt to determine a delay between the time of receipt and the GNSS time of transmission, wherein at a server, receiving a series of samples of a satellite positioning system (SPS) satellite signal from a global navigation satellite system (GNSS) receiver that is substantially co-located with the server, wherein the series of samples are timestamped with a sampling time; and
   processing the series of samples to determine a geolocation of the server; wherein performing the operation at the server is further in response to the delay being less than a maximum allowable delay, and wherein preventing the operation at the server is further in response to the delay being greater than the maximum allowable delay.
Clause 6. A method of verifying a geolocation, comprising;
   at a server, receiving a geolocation from a GNSS receiver while receiving samples of a wireless signal from the GNSS receiver;
   verifying that the samples correspond to what was known to be transmitted by a wireless signal source to verify an authenticity of the geolocation;
   performing an operation at the server in response to the geolocation of the server being within a geofence and in response to a verification of the authenticity of the geolocation; and
   preventing an operation at the server in response to the geolocation of the server being outside of the geofence and in response to a non-authentication of the geolocation.
Clause 7. The method of clause 6, wherein receiving the samples of the wireless signal comprises receiving samples of a communication satellite signal.
Clause 8. The method of clause 6, wherein receiving the samples of the wireless signal comprises receiving samples of a cellular base station signal.
Clause 9. A system, comprising:
   a GNSS receiver configured to sample a GNSS signal from a satellite to provide a series of samples, wherein the GNSS receiver is further configured to timestamp the series of samples with a time of sampling to provide a timestamped series of samples; and
   a first server configured to transmit the series of timestamped series of samples to a remote server.
Clause 10. The system of clause 9, wherein the GNSS receiver is further configured to sample the GNSS signal synchronously with an update in a navigation data overlay in the GNSS signal.
Clause 11. The system of clause 9, wherein the GNSS receiver comprises a GPS receiver.
Clause 12. A method of verifying a geolocation, comprising:
   receiving a first series of samples of a RF data signal from one of a base station, a WiFi hotspot, and a communication satellite, wherein the first series of samples were sampled at the geolocation at a first network time;
   receiving a second series of samples of the RF data signal, wherein the second series of samples were sampled adjacent the geolocation at the first network time; and
   verifying the geolocation by verifying that the first series of samples is sufficiently correlated with the second series of samples.

It will be appreciated that many modifications, substitutions and variations can be made in and to the materials, apparatus, configurations and methods of use of the devices of the present disclosure without departing from the scope thereof. In light of this, the scope of the present disclosure should not be limited to that of the particular implementations illustrated and described herein, as they are merely by way of some examples thereof, but rather, should be fully commensurate with that of the claims appended hereafter and their functional equivalents.

We claim:

1. A method of verifying a geolocation, comprising;
at a server, receiving a series of samples of a satellite positioning system (SPS) satellite signal from a global navigation satellite system (GNSS) receiver that is substantially co-located with the server, wherein the series of samples are timestamped with a sampling time;
processing the series of samples to determine a geolocation of the server;
performing an operation at the server in response to the geolocation of the server being within a geofence; and
preventing an operation at the server in response to the geolocation of the server being outside of the geofence.

2. The method of claim 1, wherein performing the operation at the server comprises accessing a database.

3. The method of claim 1, wherein performing the operation at the server comprises receiving data from a data center at the geolocation.

4. The method of claim 1, wherein the series of samples are encrypted and wherein processing the series of samples includes decrypting the series of samples.

5. The method of claim 1, wherein the series of samples are timestamped with a time of receipt, the method further comprising:
processing the series of samples to extract a GNSS time of transmission;
comparing the GNSS time to the time of receipt to determine a delay between the time of receipt and the GNSS time of transmission, wherein at a server, receiving a series of samples of a satellite positioning system (SPS) satellite signal from a global navigation satellite system (GNSS) receiver that is substantially co-located with the server, wherein the series of samples are timestamped with a sampling time; and
processing the series of samples to determine a geolocation of the server, wherein performing the operation at the server is further in response to the delay being less than a maximum allowable delay, and wherein preventing the operation at the server is further in response to the delay being greater than the maximum allowable delay.

6. A method of verifying a geolocation, comprising;
at a server, receiving a geolocation from a GNSS receiver while receiving samples of a wireless signal from the GNSS receiver;
verifying that the samples correspond to what was known to be transmitted by a wireless signal source to verify an authenticity of the geolocation;
performing an operation at the server in response to the geolocation of the server being within a geofence and in response to a verification of the authenticity of the geolocation; and
preventing an operation at the server in response to the geolocation of the server being outside of the geofence and in response to a non-authentication of the geolocation.

7. The method of claim 6, wherein receiving the samples of the wireless signal comprises receiving samples of a communication satellite signal.

8. The method of claim 6, wherein receiving the samples of the wireless signal comprises receiving samples of a cellular base station signal.

9. A system, comprising:
a GNSS receiver configured to sample a GNSS signal from a satellite to provide a series of samples, wherein the GNSS receiver is further configured to timestamp the series of samples with a time of sampling to provide a timestamped series of samples; and
a first server configured to transmit the series of timestamped series of samples to a remote server.

10. The system of claim 9, wherein the GNSS receiver is further configured to sample the GNSS signal synchronously with an update in a navigation data overlay in the GNSS signal.

11. The system of claim 9, wherein the GNSS receiver comprises a GPS receiver.

12. A method of verifying a geolocation, comprising:
receiving a first series of samples of a RF data signal from one of a base station, a WiFi hotspot, and a communication satellite, wherein the first series of samples were sampled at the geolocation at a first network time;
receiving a second series of samples of the RF data signal, wherein the second series of samples were sampled adjacent the geolocation at the first network time; and
verifying the geolocation by verifying that the first series of samples is sufficiently correlated with the second series of samples.
